(19) United States
(12) Patent Application Publication
(10) Pub. No.: US 2014/0313780 A1
(43) Pub. Date: Oct. 23, 2014

(54) FIELD-SERVICEABLE FLAT PANEL LIGHTING DEVICE

(71) Applicant: PIXI LIGHTING, INC., ORANGE, CA (US)

(72) Inventor: J. RICHARD MYERS, PASADENA, CA (US)

(73) Assignee: PIXI LIGHTING, INC., ORANGE, CA (US)

(21) Appl. No.: 14/248,197

(22) Filed: Apr. 8, 2014

Related U.S. Application Data
(60) Provisional application No. 61/812,973, filed on Apr. 17, 2013.
(60) Provisional application No. 61/917,102, filed on Dec. 17, 2013.

(51) Int. Cl. F21V 23/06

(52) U.S. Cl. CPC F21V 23/06
USPC 362/646

(57) ABSTRACT

The light fixture includes a light emitting panel assembly; and a power circuit module releasably attachable to the light emitting panel assembly. The light emitting panel assembly includes a frame, and a light emitting diode (LED) panel that is substantially flat and disposed within the frame and that includes an array of LEDs. The power circuit module includes a power circuit; a source electrical connector that electrically couples the power circuit to a power supply external to the light fixture; and a driver electrical connector that electrically couples the power circuit to the array of LEDs. The source electrical connector and driver electrical connector may be configured to be disconnected as the power circuit module is detached and separated from the light emitting panel assembly.

### CROSS REFERENCE TO RELATED APPLICATIONS

The present application claims benefit of U.S. Provisional Application. No. 61/812,973 filed Apr. 17, 2013, entitled LIGHTING ASSEMBLY, U.S. Provisional Application. No. 61/917,102 filed Dec. 17, 2013, entitled FIELD-SERVICEABLE FLAT PANEL LIGHTING DEVICE, the entire contents of which are hereby incorporated by reference.

### INCORPORATION BY REFERENCE

The present application incorporates by reference the following patent applications in their entireties:

U.S. Pat. Pub. No. 20130044512, entitled “FLAT PANEL LIGHTING DEVICE AND RETROFIT KIT,” published Feb. 21, 2013 (Ser. No. 13/473,918, filed May 17, 2012), U.S. Pat. Pub. No. 2012032062, entitled “FLAT PANEL LIGHTING DEVICE AND DRIVING CIRCUIT,” published Dec. 20, 2012 (Ser. No. 13/473,929, filed May 17, 2012); and, U.S. Pat. App. No. 61/812,973, entitled “LIGHTING ASSEMBLY” (filed Apr. 17, 2013).

### BACKGROUND OF THE INVENTION

1. Field of the Invention

The present invention relates generally to solid state lighting, such as light emitting diode (LED) lighting, and more particularly to an LED light fixture and a field-replaceable module therefor.

2. Description of the Related Art

LEDs have advantages over alternative lighting technologies including the robustness and reliability inherent in solid state devices, the lack of toxic chemicals that can be released during accidental breakage or disposal, instant-on capabilities, dimmability, and the lack of audible noise. The cost of LED luminaires is being reduced with the continuous development of the LED illuminating technology. LED light sources can be adapted to a wide range of lighting applications traditionally served by conventional technologies, such as incandescent and fluorescent illumination, and such LED light sources can enjoy significantly longer operating lives than light fixtures based upon these conventional technologies.

Over the lifetime of a lighting system, for example a commercial lighting system, the expenditures associated with operating and maintaining the system can be significant. As lighting fixtures age and deteriorate, the light-emitting ability degrades and the light output per unit of consumed electrical energy is significantly reduced. In many applications it is desirable to utilize lighting systems which facilitate maintenance of installed light fixtures, e.g. to replace certain components and extend operating life. It is particularly desirable in such applications to provide lighting fixtures that permit post-installation replacement of key components that may fail or deteriorate before the remainder of the light fixture, without requiring removal of the entire light fixture. Such components are sometimes called “field replaceable” components. The improved LED light fixtures of the present invention address these needs.

### SUMMARY OF THE INVENTION

In one embodiment, the present invention is embodied as a light fixture including a) a light emitting panel assembly; and, b) a power circuit module releasably attachable to the light emitting panel assembly. The light emitting panel assembly includes a frame; and a light emitting diode (LED) panel that is substantially flat and disposed within the frame and that includes an array of LEDs. The power circuit module includes a power circuit; a decouplable source electrical connector that electrically couples the power circuit to a power supply external to the light fixture, and a decouplable driver electrical connector that electrically couples the power circuit to the array of LEDs.

In one embodiment of the light fixture, the power supply external to the light fixture is an AC power supply, and the power circuit converts AC power to DC power to drive the LEDs.

In another embodiment of the light fixture, the power circuit comprises a printed circuit board having a length and a width, wherein a length-to-width ratio thereof is at least 10 to 1. The first driver electrical connector portion and the first source electrical connector portion may both be secured to the printed circuit board.

In yet another embodiment of the light fixture, the decouplable driver electrical connector includes a first driver electrical connector portion electrically coupled to the power circuit, and a second driver electrical connector portion electrically coupled to the array of LEDs and releasably connectable to the first driver electrical connector portion. The power circuit module may be configured to be detached and separated from the light emitting panel assembly, and the first driver electrical connector portion and second driver electrical connector portion may be configured to be disconnected and separated as the power circuit module is separated from the LED panel assembly. The first driver electrical connector portion may comprise a DC-power connector having a female configuration, and the second driver electrical connector portion may comprise a DC-power connector having a male configuration.

In a further embodiment of the light fixture, the decouplable source electrical connector includes a first source electrical connector portion electrically coupled to the power circuit, and a second source electrical connector portion electrically coupled to the power supply external to the light fixture and releasably connectable to the first source electrical connector portion. The power circuit module may be configured to be detached and separated from the light emitting panel assembly, and the first source electrical connector portion and second source electrical connector portion may be configured to be disconnected and separated as the power circuit module is separated from the light emitting panel assembly. The first source electrical connector portion may comprise an AC-power connector having a male configuration, and the second source electrical connector portion may comprise an AC-power connector having a female configuration. The second source electrical connector portion may include a luminaire disconnect.

In still another embodiment of the light fixture, the decouplable driver electrical connector includes a first driver electrical connector portion electrically coupled to the power circuit, and a second driver electrical connector portion electrically coupled to the array of LEDs and releasably connectable to the first driver electrical connector portion; and the decouplable source electrical connector includes a first source electrical connector portion electrically coupled to the power circuit, and a second source electrical connector portion electrically coupled to the power supply external to the light fixture and releasably connectable to the first source electrical connector portion. The second driver electrical connector portion and the second source electrical connector portion may both be secured to the frame of the light emitting panel assembly.

In an additional embodiment of the light fixture, the power circuit, the decouplable source electrical connector, and the decouplable driver electrical connector are disposed within a channel defined by the power circuit module and by the light emitting panel assembly. The power circuit may comprise a printed circuit board having a length to width ratio of at least ten-to-one. The decouplable driver electrical connector may include a first driver electrical connector portion secured to the printed circuit board, and the decouplable source electrical connector may include a first source electrical connector portion secured to the printed circuit board.

In a further embodiment of the light fixture, the power circuit module is releasably attachable to the light emitting panel assembly with mechanical fasteners. Alternatively or in addition, the power circuit module may be releasably attachable to the light emitting panel assembly via interference fit.

In yet another embodiment of the light fixture, the light fixture further includes a device for mounting the light fixture in an installation, and the light fixture is configured so that the power circuit module can be detached and separated from the light emitting panel assembly without removing the light fixture from the installation.

In still another embodiment of the light fixture, the light emitting panel assembly comprises an LEDs module and a remaining portion of the light emitting panel assembly, and the LEDs module contains the array of LEDs and is releasably attachable to the remaining portion of the light emitting panel assembly and to the power circuit module.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a front perspective view of the light fixture of a first embodiment of the present invention.

FIG. 2 is a rear perspective view of the light fixture of FIG. 1.

FIG. 3 is a cross-sectional view, partially in perspective, of the light fixture of the first embodiment taken along line 3-3 of FIG. 2.

FIG. 4 is a perspective view of the light fixture of the first embodiment, showing the separation of the power circuit module from light emitting panel assembly light emitting panel assembly, in progress.

FIG. 5 is a front perspective view of a light fixture of a second embodiment of the invention.

FIG. 6 is a front perspective view of a light fixture of a third embodiment of the invention.

FIG. 7 is a partially exploded, front perspective view of the light fixture of the third embodiment.

FIG. 8 is a cross-sectional view of an edge region of the light fixture of the second embodiment, taken along line 8-8 of FIG. 5.

FIG. 9 is a cross-sectional view of part of the light emitting panel assembly; and of the power circuit module of the light fixture of the second embodiment, taken along line 9-9 of FIG. 5.

FIG. 10 is a rear perspective view of the light fixture of the third embodiment.

FIG. 11 is a partially exploded, partial front perspective view of a light fixture of a fourth embodiment of the invention.

FIG. 12 is a close up perspective view of the driver electrical connector of the light fixture of the third embodiment, in the form of fixed power connectors or jacks.

FIG. 13 is a close up perspective view of the source electrical connector of the light fixture of the third embodiment, in the form of fixed power connectors or jacks.

FIG. 14 is a diagrammatic illustration of a light fixture in which the power circuitry module extends across two edge channels in accordance with a fifth embodiment of the invention.

FIG. 15 is a front perspective view of the light fixture of FIG. 14.

FIG. 16 is a rear plan view of a light fixture in accordance with a sixth embodiment of the invention.

FIG. 17 is an exploded perspective view of the light fixture of FIG. 16.

FIG. 18A is a top plan view of a side bracket from the power circuit module of the light fixture of FIG. 16. FIG. 18B is a side view of a side bracket from the power circuit module of the light fixture of FIG. 16.

FIG. 19A is a top plan view of a cover plate from the power circuit module of the light fixture of FIG. 16. FIG. 19B is a side view of a cover plate from the power circuit module of the light fixture of FIG. 16.

### DETAILED DESCRIPTION OF THE INVENTION

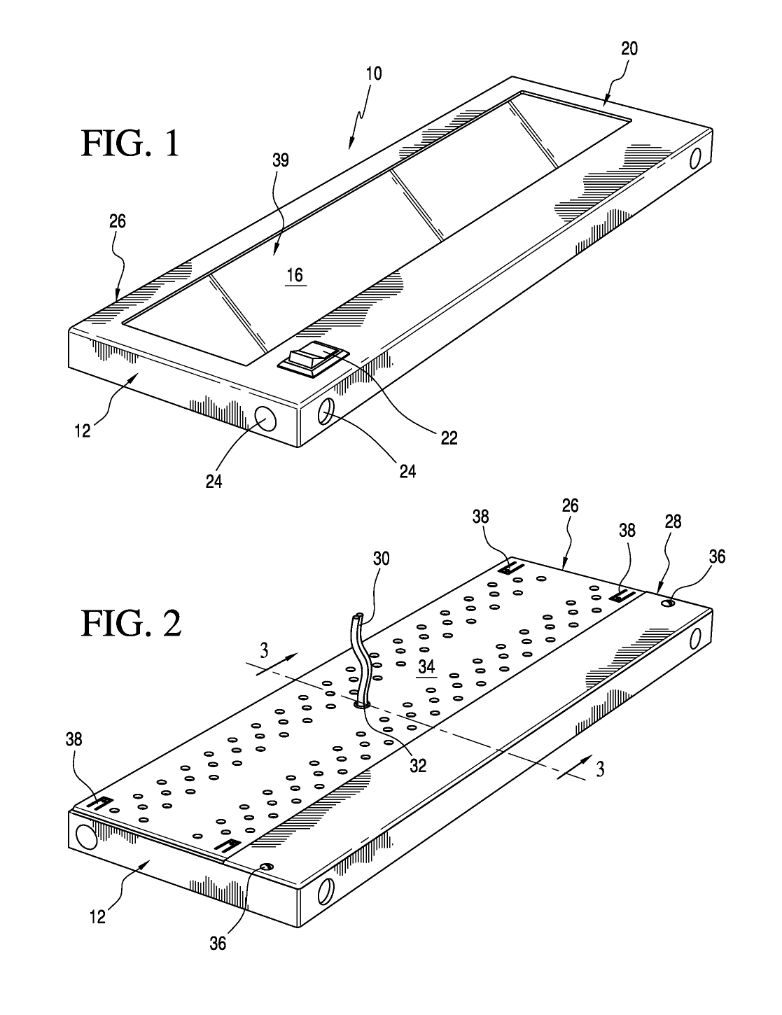

Referring now to the drawings and the characters of reference marked thereon, FIGS. 1-4 illustrate a first embodiment of an LED light fixture, designated generally as 10. As seen in FIG. 1, the light fixture 10 includes a frame 12. Light is emitted from an emission area 16 at a front surface of the light fixture 10. (In referring to the light-emitting surface of light fixture 10 as seen in perspective views such as FIG. 1 the present patent application uses the term “front” surface, and alternatively describes this surface as a “top” or “upper” structure of the light fixture 10. Similarly, this patent application uses the term “rear” or “back” surface of the light fixture 10 in referring e.g. to the rear perspective view of FIG. 2, and alternatively describes this surface as a “bottom” structure of the light fixture 10). Light is emitted from an emission area 16 at a front surface of the light fixture 10. The emission area 16 has a substantially rectangular aperture; wherein “aperture” indicates linear dimension(s) of the emission area.

Exterior features of the frame 12 include a bezel portion 20 of the frame surrounding the emission area 16. As described herein, the bezel portion 20 may serve as a cover structure for interior components of light fixture 10. The front surface of the frame 12 may include a switch 22. Additionally, appropriate openings 24 and/or other cutaways may be provided for access by wires or other electrical connectors, such as wiring carrying AC power in, wiring carrying DC power in, and/or wiring carrying DC power out.

As seen in the FIGS. 2-4, light fixture 10 includes two major subassemblies, a light emitting panel assembly 26 and a power circuit module 28. Power circuit module 28 is releasably attached to the light emitting panel assembly 26, to facilitate removal and replacement of the power circuit module 28 after installation of the light fixture 10. As seen in the bottom perspective view of FIG. 2, light emitting panel assembly 26 and power circuit module 28 are fitted side-by-side within frame 12, which surrounds the outer edges of these subassemblies. FIG. 2 shows power lines or leads 30 running from a wiring ingress structure, e.g. grommet 32, at the rear surface 34 of light emitting panel assembly 26. Leads 30 provide power to light fixture 10 from an external power supply (not shown), for example an AC power supply such as a junction box. Mechanical fasteners 36 secure power circuit module 28 to light emitting panel assembly 26. Frame 12 is part of light emitting panel assembly 26, and may be integrally formed with other components of light emitting panel assembly 26 or may be permanently or releasably attached to these other components.

Mounting tabs 38 with apertures may be used to mount light fixture 10 in various installations. For example, as described in U.S. Pat. Pub. No. 20130044512, entitled “FLAT PANEL LIGHTING DEVICE AND RETROFIT KIT,” published Feb. 21, 2013 (Ser. No. 13/473,918, filed May 17, 2012), the aperture mounting tabs may be folded 90 degrees from the rear surface 34 of light fixture 10 to hang the light fixture from a ceiling using wires secured through the tab apertures, also called pendant mounting.

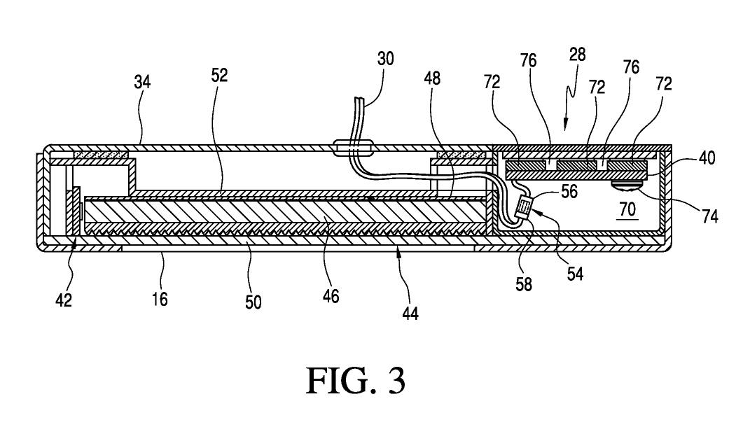

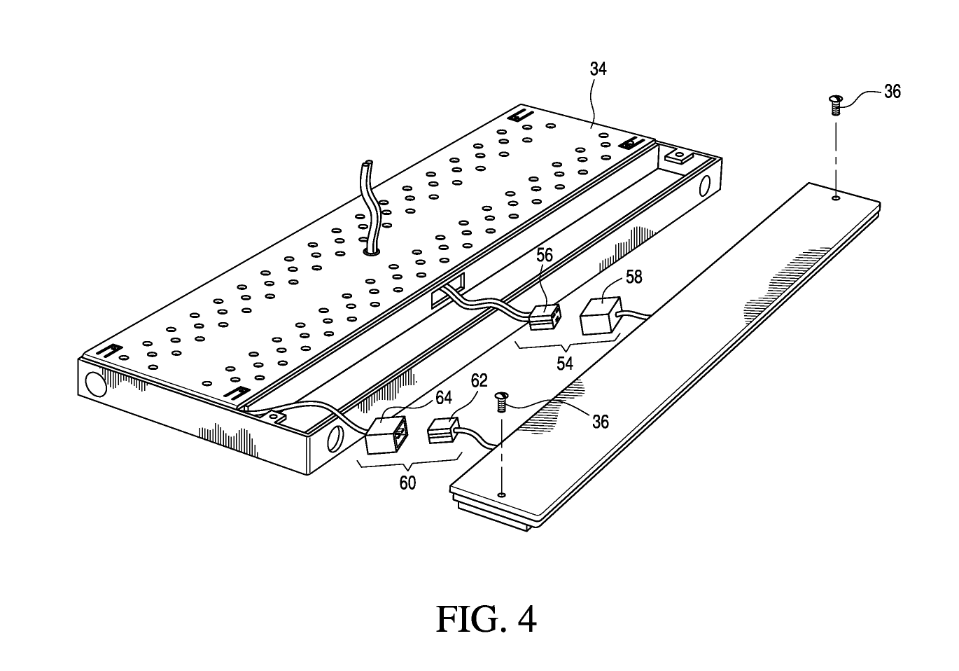

Referring to FIG. 3 (a view of section 3-3 in FIG. 2) and FIG. 4, major components of light emitting panel assembly 26 include frame 12 and a substantially flat light emitting diode (LED) panel 39. In a preferred construction of light fixture 10, the frame 12 is comprised of a metal, a metal alloy, or a composite material including a metal. For example, the frame may be comprised of ferrous metals, or non-ferrous metals such as aluminum, brass, bronze, copper, and stainless steel. The frame may include a surface treatment such as electroplating or powder coating. Surface treatments for improved durability, such as rust-proofing, may be applied to frame 12.

The substantially flat light emitting diode (LED) panel 39 is disposed within the frame 12. The light emitting diode (LED) panel 39 includes an optically transmissive panel assembly 44; and, the set of light emitting diodes (LEDs) 42 extending adjacent an edge surface of the optically transmissive panel assembly, sometimes referred to as an LED bar or LED strip. The term “substantially flat light emitting diode (LED) panel” as used in connection with the description of the various embodiments, is meant to include LED panels having a thickness that is substantially less than the length and width of the LED panel. As used in the present patent application, the term “light emitting diodes” (or “LEDs”) optionally includes a lens or other optical interface (not shown) between the LEDs 42 and the optically transmissive panel assembly 44.

The light fixture 10, including the substantially flat LED panel 39, may take on a variety of dimensions and form factors, including, but not limited to, rectangular, other polygonal (e.g. octagonal), circular and elliptical form factors. For example, the light fixture 10 can be rectangular with a size of approximately two feet by four feet (2 feet×4 feet), corresponding to an exemplary lower dimension of a standard fluorescent ceiling troffer. In another exemplary embodiment, the light fixture 10 can have dimensions of about one foot by about four feet. In yet another exemplary embodiment, the light fixture 10 can be sized to standard lengths for under counter or under cabinet lighting applications (12 inches, 18 inches, 24 inches, 36 inches, etc.).

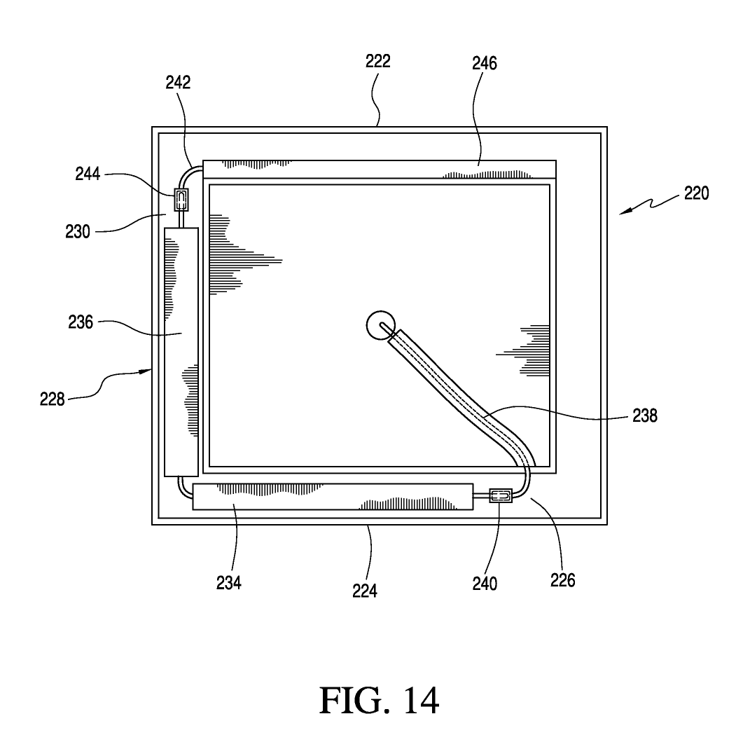

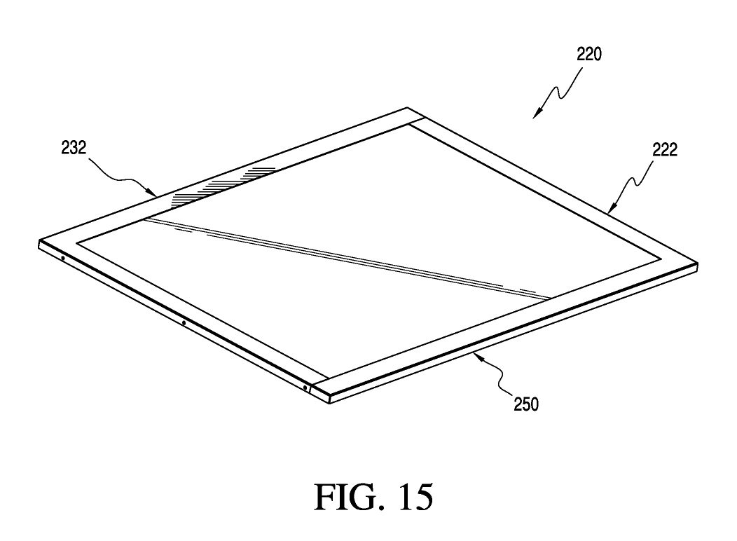

The power circuit module and the light emitting panel assembly may have a variety of configurations within the overall form factor of the light fixture. Typically, the power circuit module is located at one edge of the light emitting panel assembly, but it is also possible to locate the power circuit module at an interior space surrounded by the light emitting power assembly. It is also possible for the power circuit module to be located at more than one edge of the light emitting panel assembly, as in the embodiment of FIGS. 14 and 15, in which the power circuit module occupies two edges of the light fixture 220. The power circuit module is preferably an elongate structure in keeping with the preferred nature of the power circuit contained within the power circuit module. Along its long axis, the power circuit may occupy all or part of the width of the light fixture, any remaining width being occupied by the frame of the light emitting panel assembly. The power circuit module may occupy all or part of the height of the light fixture, any remaining height being occupied by the frame of the light fixture. For example, in the embodiment of FIGS. 1-4, the power circuit module 28 occupies the height of the light fixture 10 except for the bezel 20 that is part of the frame 12 at the front surface of light fixture 10; in the embodiment of FIGS. 6 and 10 the power circuit module 146 occupies the height of light fixture 144 except for the frame 158 at the rear surface of the light fixture.

Referring to FIG. 3, a power circuit 40 in power circuit module 28 is operatively coupled to an AC power supply external to the light fixture 10 (as discussed above), and converts the AC power to DC power to power the set of light emitting diodes (LEDs) 42. The set of LEDs 42 may be supported by a heat dissipating structure, such as one or more array, strip, or bar of LEDs. Various forms of LEDs packaging may be employed, including for example surface mounted packages that mount LEDs to a printed circuit board. Surface mounting of LEDs typically dissipates heat efficiently. However, it is understood that other LEDs packaging such as pin mounted LEDs may be utilized.

The optically transmissive panel assembly 44 encompasses all light-transmissive, reflective, or refractive structures in the light path from the sets of light emitting diodes (LEDs)—but not including these LEDs or any lens or other optical interface adjacent the LEDs—to the emission area 16. In one embodiment, as shown in FIG. 3, the optically transmissive panel assembly 44 includes a light guide plate (LGP) 46 in combination with light-reflective and light-transmissive films, sheeting, or coatings. The optically transmissive panel assembly 44 may include separate component parts assembled during production of light fixture 10, or may comprise a composite structure. LGP 46 may be comprised of an extremely transparent plastic material such as an acrylic or polycarbonate resin; e.g. LGP 46 may be made from poly(methyl methacrylate) (PMMA) resin. On the bottom of the light guide plate a matrix of lines or microstructures can be formed, dots can be printed, or particulates can be added to the panel polymer.

In the embodiment of FIG. 3, optically transmissive panel assembly 44 includes the light guide plate (LGP) 46, reflector 48 (also referred to as a reflective film), and a diffuser 50 at the front surface (emission area 16) of the optically transmissive panel assembly 44. In an advantageous embodiment, diffuser 50 comprises a hard transparent plastic sheet that also serves to seal or water-proof light fixture 10 at its front surface. This diffuser sheet 50 may be covered at its edges by the bezel 20 and silicone potting material (not shown) may be used under the bezel 20 to support the diffuser 50.

The reflector 48 reflects light that is refracted out of the bottom surface back through the light guide plate 46. The diffuser 50 scatters the light received from the light guide plate 46. Instead of or in addition to the diffuser, the light-transmissive sheeting or film can be configured to modify or otherwise direct the distribution of light received from the reflection panel in a variety of ways (also herein called “patterning film”; as used herein, this term encompasses thin flexible films as well as rigid and semi-rigid sheeting). Various types and uses of patterning films in LED panel lighting fixtures are disclosed in U.S. Patent Application No. 61/812,973, “LIGHTING ASSEMBLY”.

Referring further to FIG. 3, the light emitting panel assembly includes rear cover 34 which fits within frame 12 adjacent the power circuit module 28, and a platform 52 which supports the components of the substantially flat light emitting diode (LED) panel 39. AC input line 30 runs from wire inlet or grommet 32, routed between rear cover 34 and platform 52, to power circuit module 28. Within the power circuit module 28, the AC line includes a source electrical connector 54 that forms a releasable electrical connection to the power circuit 40. As seen in FIG. 3 and further described with reference to FIG. 4, source electrical connector 54 comprises a first source electrical connector portion 58 electrically coupled to power circuit 40, and a second source electrical connector portion 56 electrically coupled to the AC power source (not shown) external to light fixture 10. FIG. 4 also shows a driver electrical connector 60 that forms a releasable electrical connection of the power circuit 40 to the set of LEDs 42. The driver electrical connector 60 comprises a first driver electrical connector portion 62 electrically coupled to power circuit 40, and a second driver electrical connector portion 64 electrically coupled to the set of LEDs 42.

The electrical connectors of FIGS. 3 and 4 exemplify mobile power connectors or plugs, i.e. electrical connectors that are not fixed in place. For example, the source electrical connector 54 may comprise three-pin AC-power connector plugs with internal male and female pin configurations. For safety reasons, the first source electrical connector portion 58 electrically coupled to power circuit 40 preferably has a male pin configuration, while the second source electrical connector portion 56 electrically coupled to the AC power source preferably has a female pin configuration. In this way, the electrical connector portion coupled to the AC power source has concealed contacts to prevent inadvertent touching of live conductors carrying voltage or current sufficient to cause injury. The driver electrical connector 60 may comprise two-pin DC-power connector plugs with internal male and female pin configurations. The first driver electrical connector portion 62 electrically coupled to power circuit 40 preferably has a female pin configuration, while the second driver electrical connector portion 64 electrically coupled to the LEDs 42 preferably has a male pin configuration.

Power circuit module 28 includes a cover or shell 66 releasably attached within frame 12 next to the rear cover 34 of light emitting panel assembly 26. Power circuit, also called driving circuit, is shown as a circuit board (but omitting mounted components) in FIG. 3. Power circuit 40 is configured to have a relatively long and narrow form factor, and a compact configuration compatible with narrow widths and limited height, allowing it to be housed within a first channel 70 defined within the shell 66. In one embodiment, the power circuit 40 comprises a printed circuit board having a length-to-width ratio of at least 10 to 1. For example, power circuit 40 may have dimensions of approximately 20 centimeters in length, approximately 15 millimeters of width and approximately 15 millimeters in height. It will be appreciated that the disclosed technology is not limited to these exemplary dimensions. The first channel 70 within power circuit module 28 can take on other dimensions without departing from the scope of the disclosed technology. Such a compact power circuit can be obtained by employing miniaturized power boards and components.

Metal heat sink backing pieces 72 (here shown in section) between the power circuit and shell 66 may comprise three aluminum pieces that collectively are of similar length and width to the dimensions of power circuit board. These heat sink backing pieces may include slits 76 along their length in order to facilitate heat dissipation. A fastener 74 secures the power circuit to the shell 66; different than the mechanical fasteners 36 that releasably attach the power circuit module to the light emitting panel assembly 26.

The light fixture 10 of FIGS. 1-4 is configured to permit installation of the light fixture, and convenient removal and replacement of the power circuit module 28 during routine maintenance or other event such as failure of power circuit 40. The light fixture embodiment of FIGS. 1-4 is configured for removal and replacement of the power circuit module 28 from the rear of the light fixture without removal of the remainder of light fixture 10 from its installation, such as a pendent or hanging lighting installation. FIG. 4 illustrates detachment and separation of the power circuit module 28 from the light emitting panel assembly 26. Fasteners 36 have been removed, and power circuit module has been pulled out of the remainder of light fixture 10 from the rear. Once the power circuit module is separated from the light emitting panel assembly, completing the removal of the power circuit module requires decoupling of the source electrical connector 54 and the driver electrical connector 60. The first source electrical connector portion 58 is disconnected from the second source electrical connector portion 56, and the first driver electrical connector portion 62 is disconnected from the second source electrical connector portion 64. The first source electrical connector portion and first driver electrical connector portion remain with the power circuit module 28, which can now be removed. The second source electrical connector portion and second driver electrical connector portion remain with the light emitting panel assembly 26. A replacement power circuit module (not shown) may then be electrically coupled to these electrical connector portions and mechanically attached to the light emitting panel assembly 26.

LED light fixtures in accordance with the present invention may incorporate one or more field-replaceable power circuit module in a variety of configurations, which may depend for example on the manner in which the light fixture is intended to be mounted. Pending mounting of the light fixture 10 of FIGS. 1-4, and removal from the rear of the power circuit module from the rear, is described above. In another example, in recessed mounting the LED light fixture may be configured to be mounted within a recess in a wall, ceiling or other surface, leaving only the front surface of the light fixture exposed. In this type of installation, the light fixture may be configured to remove and replace the power circuit module from the front surface of the light. In a surface mount installation, the light fixture may be mounted to a wall, ceiling, under-cabinet or under-counter surface, or other surface so as to leave the light fixture exposed. In this type of installation, the light fixture may be configured to remove and replace the power circuit module from a side surface of the light fixture. LED light fixture embodiments with front-removable power circuit modules, and with side-removable power circuit modules, are described below.

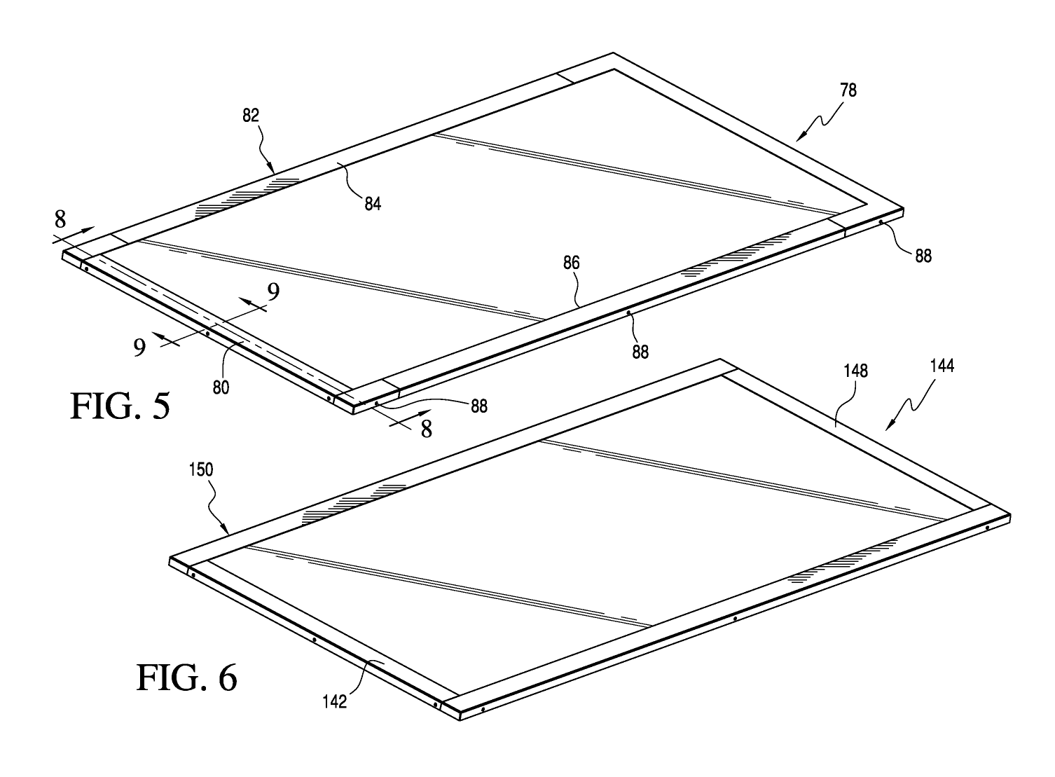

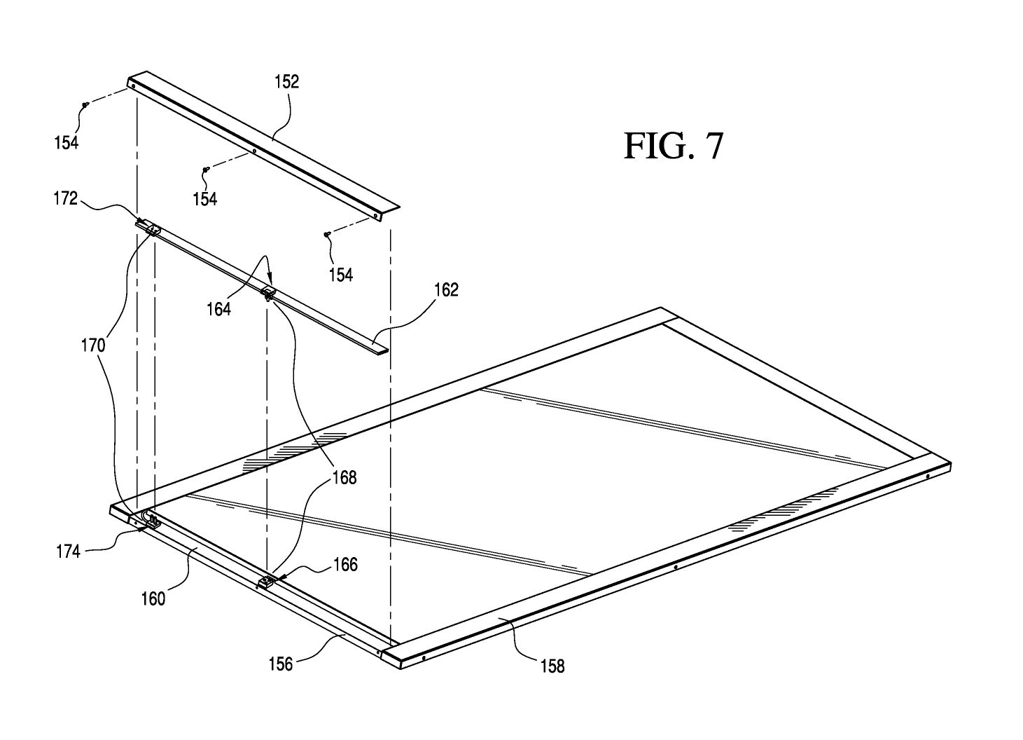

Turning now to FIGS. 5-13, these views illustrate further embodiments in which one or more power circuit module is configured to be removed from the front of the light fixture, and configured to be removed from the side of the light fixture, respectively. FIG. 5 is a front perspective view of light fixture 78 with a power circuit module 80 releasably attached to the remainder of the light fixture (light emitting panel assembly 82) at one of the short edges of the light fixture. Light fixture 78 also includes LEDs modules 84 and 86 at both long edges of the light fixture, releasably attached to fixture 78 e.g. using fasteners 88. FIG. 6 is a front perspective view of light fixture 144 with two power circuit modules 146 and 148, respectively located at the short edges of the light fixture 144 and releasably attached to the light emitting power assembly 150 comprising the remainder of the light fixture.

Referring generally to FIGS. 6, 7, 10, 12 and 13, FIG. 7 shows the light fixture of FIG. 6 with an exploded view of the components of one of the power circuit modules 146, which is configured to be removed from the front surface of light fixture 144. A similar power circuit module 148 (the components of which are not shown) is located at the opposite end of light fixture 144, and power circuits within these power circuit modules 146 and 148 drive two arrays of LEDs (not shown) at opposite long sides of light fixture 144. An L-bracket cover plate 152 releasably attached to light fixture 144 by screws 154, and a base area 156 of frame 158 below the L-bracket, define between them a first channel 160. First channel 160 contains a horizontally extending circuit board 162, and first source electrical connector portion 164 and second source electrical connector portion 166 that respectively form a source electrical connector 168 located at or near the center of circuit board 162, and first driver electrical connector portion 172 and second driver electrical connector portion 174 that respectively form a driver electrical connector 170 located near one edge of circuit board 162. Source electrical connector 168 and driver electrical connector 170 exemplify fixed power connectors or jacks, including complementary electrical connector portions fixed in place below the circuit board 162 and above the base area 156 of frame 158.

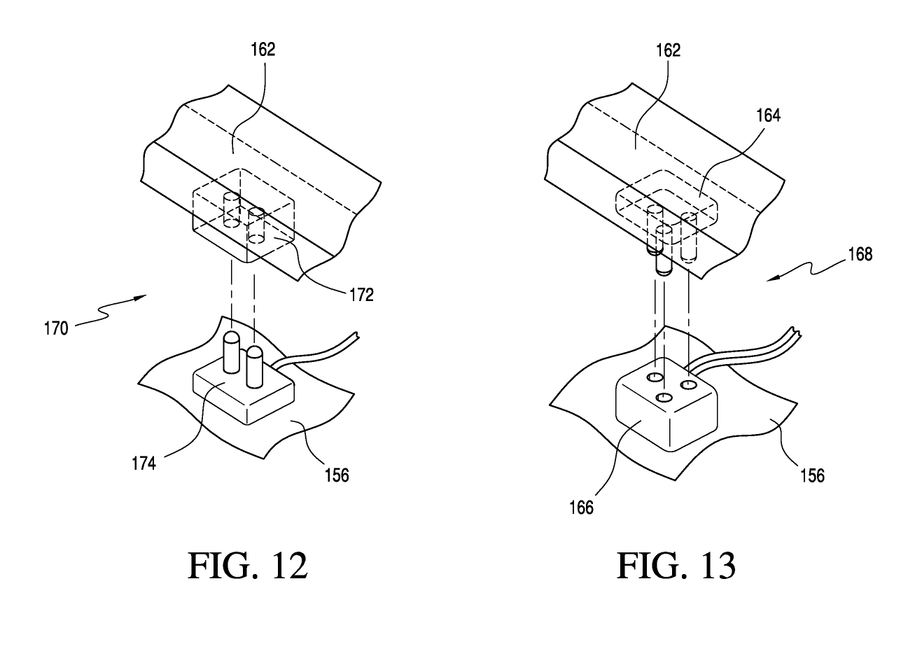

FIG. 12 shows the driver electrical connector 170 as complementary two-pin DC-power jacks including a first driver electrical connector portion 172 (female pin configuration) facing downwardly below circuit board 162, and a second driver electrical connector portion 174 (male pin configuration) facing upwardly on base area 156. FIG. 13 shows the source electrical connector 168 as complementary three-pin AC-power jacks including a first source electrical connector portion 164 (male pin configuration) facing downwardly below circuit board 162, and a second source electrical connector portion 166 (female pin configuration) facing upwardly on base area 156. During removal of the power circuit module 146 from the front surface of light fixture 144, these power connector jacks are disengaged at the same time that the power circuit module is separated from the light emitting panel assembly 150 of fixture 144. During replacement with a new power circuit module (not shown), the power connector jacks are reengaged as the power circuit module is lowered into place to be attached to the light fixture 144. Although FIGS. 12 and 13 illustrate electrical connectors with female pin configurations and male pin configurations, a wide variety of other male-female configurations are known in the art, such as plug-and socket connectors, blade connectors, and a variety of hybrid connectors.

FIG. 10 shows a rear perspective view of the light fixture 144 of FIG. 6. As described in more detail in applicant's patent application entitled FLAT PANEL LIGHTING DEVICE, U.S. Provisional Application No. 61/917,059, filed Dec. 17, 2013, two wire-ways 176 and 178 are mounted to the rear surface 180 of light fixture 144. Wire-ways 176 and 178 respectively route AC leads 182 from a wire compartment 184 at a long edge of frame 158; the AC leads or wires 182 are routed from a wire ingress opening 186 to the wiring compartment 184 from an external AC power supply (not shown). Wire-ways 176 and 178 respectively communicate with the power circuit modules 146 and 148 at opposite short ends of the light fixture 144 to route the AC leads to the power circuit modules. The light fixture 144 includes a luminaire disconnect 188, i.e. a device to disconnect the AC power from the downstream portion of the AC leads at the wire compartment. Alternative locations of a luminaire disconnect can include location 190 (at the wire-way 176), and location 192 (at a junction of the wire-way to the power circuit module 146).

Now turning to FIGS. 5, 8, and 9, FIG. 8 shows a partial longitudinal section of the power circuit module 80 encompassing a portion of the first channel 89 within the power circuit module, and a section of a second channel 90 adjacent one end of the power circuit module 80. Power circuit 92 on a horizontally oriented circuit board 94 is attached to a cover 96 of the power circuit module via a heat sink 98 that extends along the length of the circuit board. A first driver electrical connector portion 100, consisting of a DC-power jack having a female pin configuration, is mounted below circuit board 94 near the end of the circuit board, facing downwardly. First driver electrical connector portion 100 is coupled to a second driver electrical connector portion 112 consisting of a DC-power jack having a male pin configuration and supported by the frame 114 of light fixture 78. A first source electrical connector portion 116, consisting of an AC-power jack having a male pin configuration, is mounted below circuit board 94 near the center of the circuit board (toward the right side of this partial view), facing downwardly. First source electrical connector portion 116 is coupled to a second source electrical connector portion 118 consisting of an AC-power jack having a female pin configuration and supported by the frame 114 of light fixture 78. The first and second source electrical connector portions 116, 118 are electrically coupled to form the source electrical connector 120 while the first and second driver electrical connector portions 100, 112 are electrically coupled to form the driver electrical connector 122.

DC power leads 124 extend from the second driver electrical connector, through a dam 126 and through an aperture in the cover 128 of power circuit module 80, to be electrically coupled to a set of LED's in a second channel 90 adjacent power circuit module 80, this second channel 90 extending into this view along one of the long sides of light fixture 78. The set of LEDs 130 are surface mounted to a circuit board supported by an L-shaped bar 132. As seen in FIG. 5, the set of LEDs and supporting structures within second channel 90 may be part of LEDs module 84 that releasably attached at one of the long sides of light fixture 78. The LEDs module 84 may be detached and removed from light fixture 78, including electrical disconnection from the driver electrical connector 122, then replaced with a new LEDs module, using a similar procedure to the procedure for removing and replacing a power circuit module.

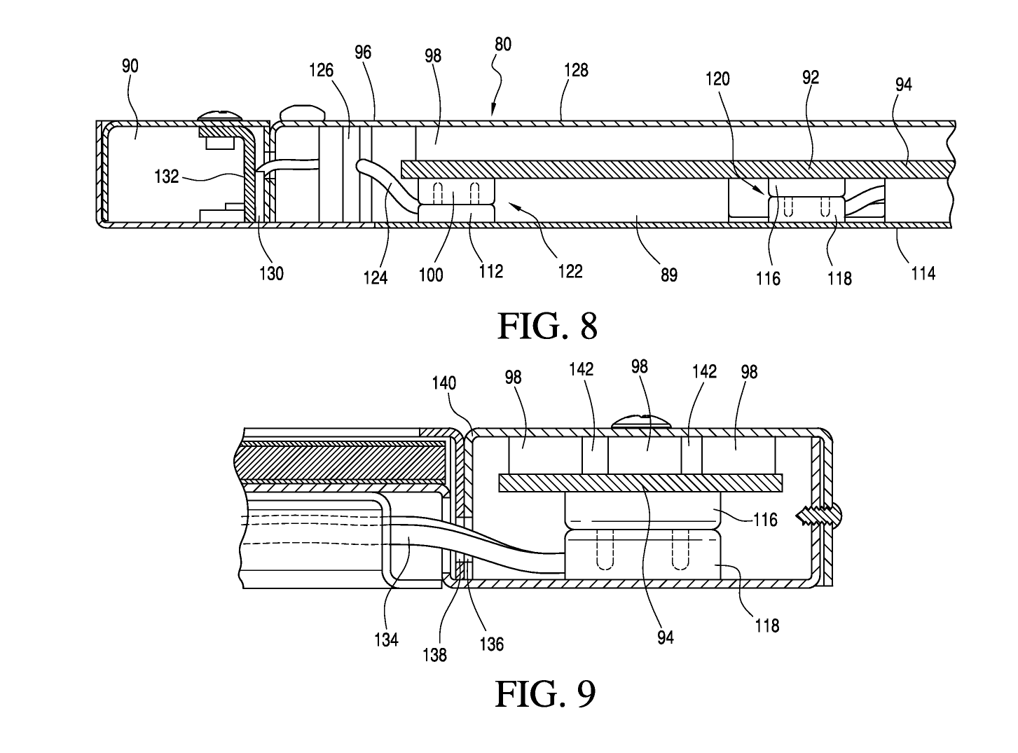

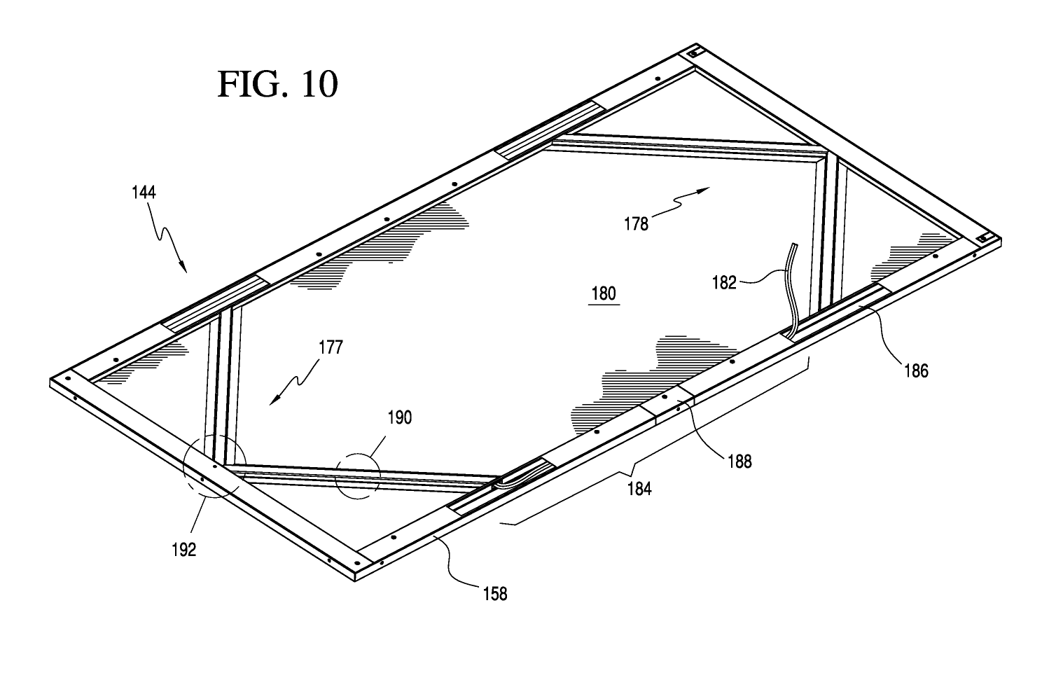

FIG. 9 shows in cross-section a central area of power circuit module 80, and a partial cross section of an adjacent portion of the light emitting panel assembly 82. Referring to FIGS. 8 and 9, AC power leads 134 extend from the second source electrical connector portion 118, through adjacent openings 136, 138 in the cover 128 of the power circuit module and cover 140 of the light emitting panel assembly 82, to be routed to an AC power supply (not shown) external to the light fixture 78. Other elements of the light emitting panel assembly 82, such as optically transmissive panel assembly, may be generally similar to those shown in FIG. 3. Similar to the embodiment of FIG. 3, the circuit board 94 may be coupled to cover 128 using metal heat sink backing pieces 98, which may comprise three aluminum pieces that collectively are of similar length and width to the dimensions of the power circuit board. These heat sink backing pieces may include slits 142 along their length in order to facilitate heat dissipation. First and second source electrical connector portions 116 and 118 are shown coupled below circuit board 94.

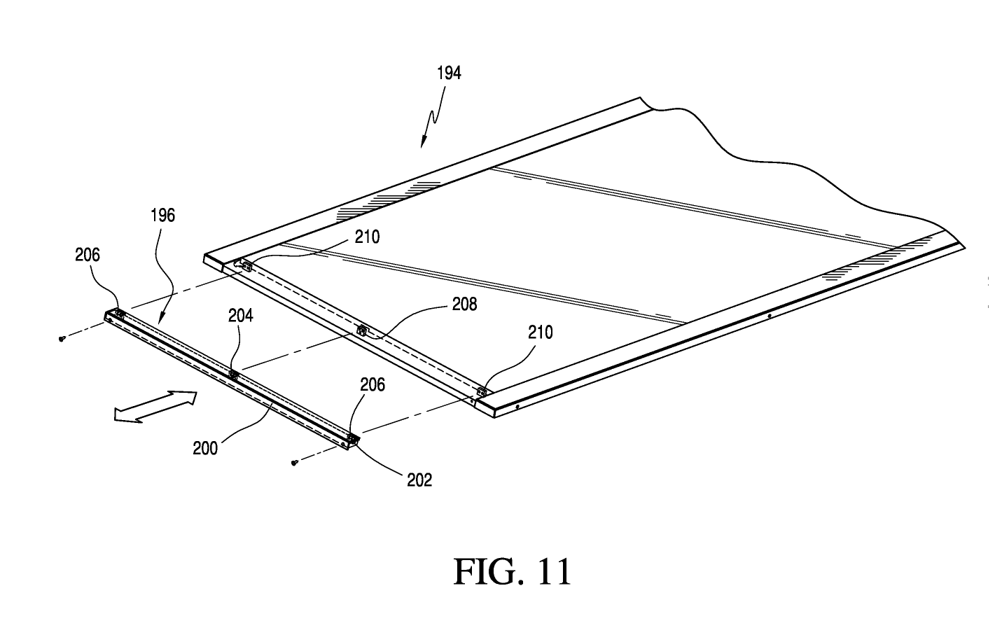

FIG. 11 shows a further light fixture 194 embodiment with a power circuit module 196 removed. Power circuit module 196 is configured to be removed from a side surface 198 of light fixture 194. Power circuit module 196 includes L-bracket 200; circuit board 202 pending from L-bracket 200 in a vertical orientation; first source electrical connector portion 204 secured at or near the center of the circuit board; and a pair of first driver electrical connector portions 206 secured at opposite ends of circuit board 202. The separation of power circuit module 196 from light fixture 194 reveals a second source electrical connector portion 208, and a pair of second driver electrical connector portions 210. The source electrical connector portions 204 and 208 advantageously consist of complementary three-pin AC-power jacks similar to those shown in FIG. 13, but with a side-facing orientation. Each of the pair of driver electrical connector portions 206, 210 advantageously consist of complementary two-pin DC-power jacks similar to those shown in FIG. 12, but with a side-facing orientation. During removal and replacement of power circuit module 196 from the side, these power connector jacks are disengaged as the power circuit module is separated from the light fixture 194, and are reengaged as a new power circuit module is attached to the light fixture 194.

Turning now to FIGS. 14 and 15, lighting fixture 220 includes a frame 222 with a first edge 224 adjacent a first edge channel 226, and a second edge 228 adjacent a second edge channel 230. Power circuit module 232 occupies both edges 224 and 228, while light emitting panel assembly 250 comprises the remainder of light fixture 220, as best seen in FIG. 15. The first edge channel 226 contains a first power circuit portion 234 comprising an AC/DC transformer, while the second edge channel 230 contains a second power circuit portion 236 comprising a DC power supply. First power circuit portion 234 receives AC power via line 238 including decouplable source electrical connector 240, electrically coupled to an AC power source (not shown). Second power circuit portion 236 provides DC power to LEDs array 246 via line 242 including decouplable driver electrical connector 244. Multiple-piece driving circuit layouts are disclosed in applicant's U.S. Provisional Application No. 61/812,973 filed Apr. 17, 2013, entitled LIGHTING ASSEMBLY.

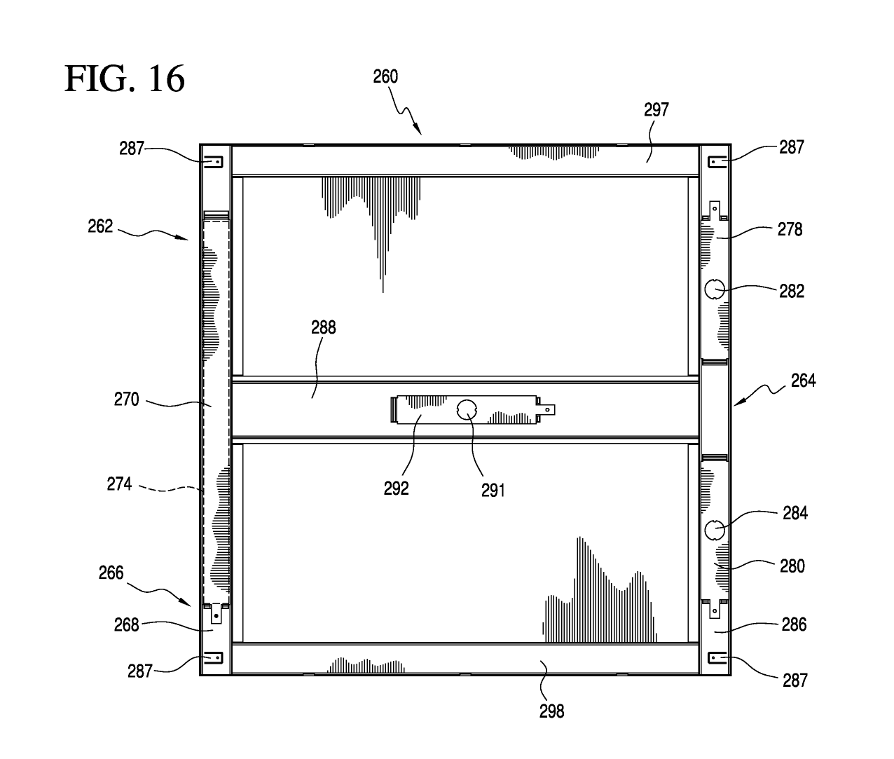

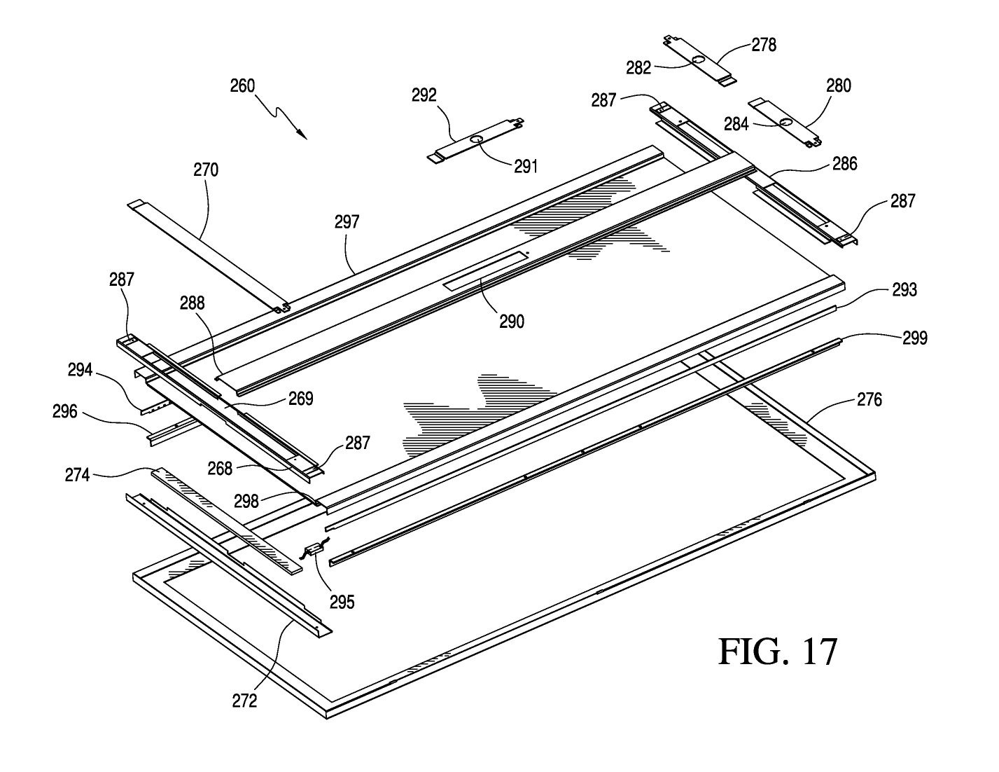

FIGS. 16-19 show a further light fixture embodiment 260, including a power circuit module 262 and light emitting panel assembly 264. Power circuit module 262 occupies most of one edge 266 of light fixture 260, while light emitting panel assembly 264 comprises the remainder of light fixture 260. Power circuit module 262 includes rear cover structures including side bracket 268 and cover plate 270, which is releasably mounted within an access aperture 269 in side bracket 268. Inside channel 272, together with the rear cover structures, define an edge channel that houses the power circuit (circuit board) 274. For example, power circuit 274 can be secured to inner face of the cover plate 270. Power circuit modules also include decouplable electrical connectors (not shown), including a source electrical connector that electrically couples the power circuit 274 to a power supply (not shown) external to light fixture 260, and a driver electrical connector that electrically couples the power circuit 274 to two arrays of LEDs 293, 294.

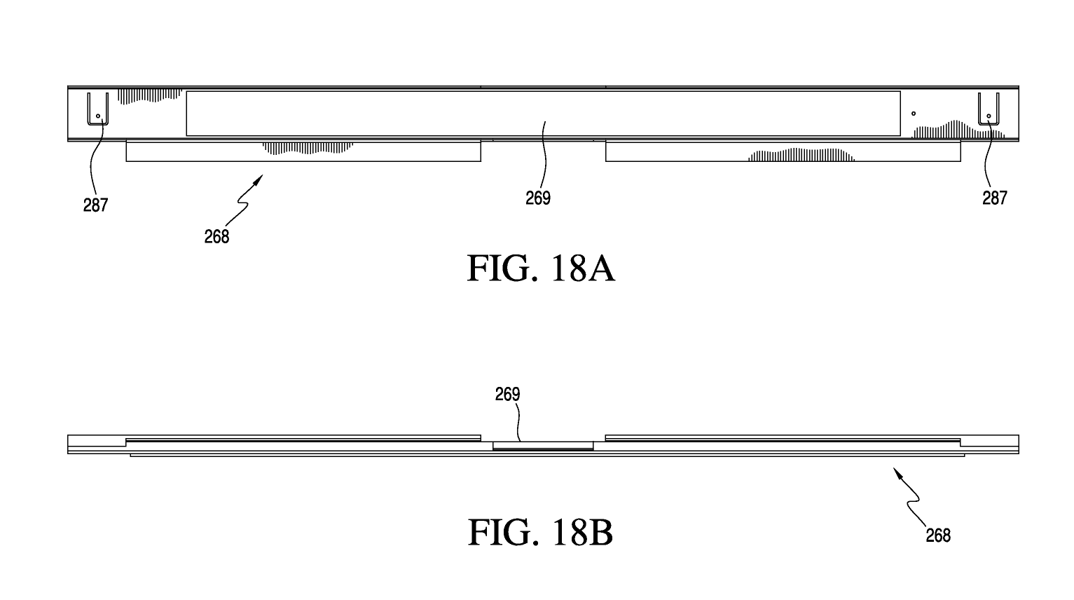

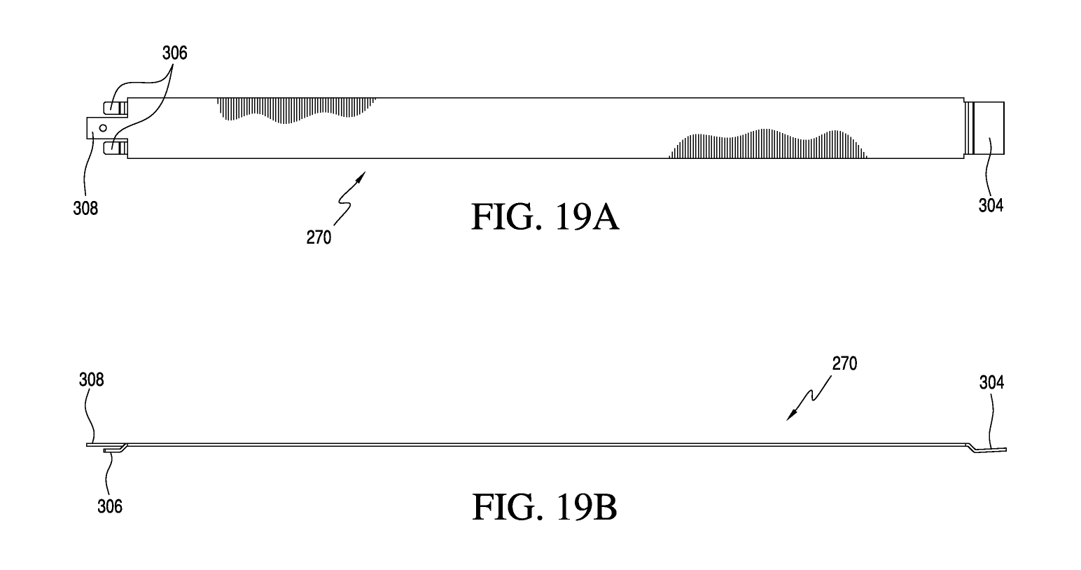

The mounting and removal of the power circuit module 262 to and from the light emitting panel assembly 264 advantageously uses a mechanism disclosed in U.S. Pat. Pub. No. 20130044512, entitled “FLAT PANEL LIGHTING DEVICE AND RETROFIT KIT,” published Feb. 21, 2013 (Ser. No. 13/473,918, filed May 17, 2012) for a knockout bracket, in this case applied to the mounting of cover plate 270 to side bracket 268. This procedure can be understood with reference to FIG. 17, the plan and side detail views of side bracket 268 of FIGS. 18A and 18B, and the plan and side detail views of cover plate 270 of FIGS. 19A and 19B. Cover plate 270 can be secured within the access aperture 269 at one end by a downwardly offset flange 304, and at the other end by downwardly offset forks 306, including an apertured tab 308 between the forks and substantially coplanar with the main body of the cover plate. In accordance with an exemplary embodiment, to insert the cover plate 270 within the cut out (access aperture 269) at the center of the side bracket 268, the user can insert the flange 304 under the side bracket adjacent one side of the access aperture, then pivot the other end of the cover plate into the access aperture cutout. The user would then slide the forked end 306 of the cover plate under the other end of the access aperture, with the apertured tab 308 resting above the side bracket's edge surface. The cover plate 270 can be secured to the side bracket 268 using a screw at the apertured tab 308.

In an embodiment in which circuit board 274 is secured to the inner face of cover plate 270, the process of removal of the power circuit module 262 from the light emitting panel assembly 264 may be similar to the removal process shown in FIG. 4 for the lighting fixture of FIGS. 1-4. For example, the user may decouple driver electrical connector 295 in order to disconnect power circuit 274 from LEDs strip 293. (The source electrical connector, and another driver electrical connector to LEDs strip 294, are not shown in FIG. 17). The user may decouple the source electrical connector and driver electrical connector after removing and slightly separating the cover plate 270 from the side bracket 268 in order to provide access to these electrical connector portions.

Referring again to FIGS. 16 and 17, light emitting panel assembly 264 includes frame 276 forming a bezel at the front surface of the light, and a rear cover 297. The central portion of rear cover 297 serves as a platform to support the substantially flat light emitting diode (LED) panel, not shown. Shoulders 298 at the outer edges of rear cover 297 house LED strips 293, 294 respectively mounted on inside brackets 299, 296. Inside brackets 296, 299 advantageously serve as heat sinks to dissipate heat generated by LEDs 293 and 294. Light fixture 260 includes a side bracket 286 at the opposite edge from side bracket 268; these side brackets include mounting tabs 287 at the four corners of light fixture 260. Mounting tabs 287 may comprise three-position tabs (0°, 90°, 180° as described in U.S. Pat. Pub. No. 20130044512, entitled “FLAT PANEL LIGHTING DEVICE AND RETROFIT KIT,” published Feb. 21, 2013 (Ser. No. 13/473,918, filed May 17, 2012).

U.S. Pat. Pub. No. 20130044512 also discloses another feature of lighting fixture 260: wiring compartments at the edge of light fixture 260 (side bracket 286), and central wire-way 288 extending between side bracket 268 and side bracket 286. Wire compartments, defined in part by side bracket 286, are accessed by two apertures respectively covered by knockout bracket 278 and knockout bracket 280. Knockout brackets 278 and 280 respectively include knockout apertures 282, 284, which provide ingress points for receiving AC power from an external source. Knockout brackets 278, 280 may be secured within the access apertures of side bracket 280 using the mechanism described above for side bracket 268 and cover bracket 270.

U.S. Pat. Pub. No. 20130044512 additionally discloses a further feature of lighting fixture 260: a central wire-way 288 extending between side bracket 268 and side bracket 286. Wire-way 288 serves as a cover (in combination with rear cover 297) for wires or cables routed between side bracket 268 and side bracket 286. Wire-way 288 also serves as a cover for wires routed between side bracket 268 and a knockout bracket 292 secured to central aperture 290 of wire-way 288. In addition, wire-way 288 may provide additional stiffness of light fixture 260. Knockout bracket 292 advantageously includes knockout aperture 291, and provides a central wiring ingress point similarly to the edge wiring ingress provided by knockout brackets 278, 280. Knockout bracket 292 may be secured to central wire-way 288 using the same mechanism as described above for side bracket 268 and mounting plate 270.

This application commonly uses the phrase “releasably attached” to describe the non-permanent mechanical attachment of the power circuit module from the light emitting panel assembly, but other terms may be used such as “removable” and for a process of “removing” or “separating” the power circuit module from the light emitting panel assembly. Similarly, the term “releasably attachable” may be used herein, for example to describe providing the light fixture with the power circuit module and the light emitting panel assembly as separate subassemblies, wherein these subassemblies would be attached prior to installation of the light fixture. This application commonly uses the phrase “electrically coupled”, and sometimes uses other terms such as simply “coupled”, to describe the electrical communication of various electrical components of the light fixture, and of electrical components of the light fixture to a power source external to the light fixture. It should also be recognized that electrical coupling of electrical components of the light fixture may also involve the physical attachment of these electrical components. The term “releasably connectable” may be used herein, for example to describe providing the light fixture with the power circuit module and the light emitting panel assembly as separate subassemblies with electrical components disconnected, wherein these electrical components would be coupled when attaching the power circuit module and the light emitting panel assembly prior to installation of the light fixture.

There can be various modifications and variations. For example there can be additional configurations and additional procedures for electrically coupling “electrical connector portions”, a term that can be used to some or all of the first source electrical connector portion, first driver electrical connector portion, second source electrical connector portion, and second driver electrical connector portion. Electrical connectors types include but are not limited to male-female connectors. As used in the present application the terms “male configuration” and “female configuration” referring to the electrical connector portions can include a wide variety of male-female connector types. The electrical connector portions can include additional features such as mechanical interlock; these electrical connector portions can include additional configurations such as guide profiles to facilitate joining and electrical coupling the electrical connector portions, and locking structures such as slide-locks. In addition, the process for attaching (and conversely, detaching) the power circuit module to the light emitting panel assembly can include additional motions such as rotation or lateral sliding to engage an interference fit of the power circuit module to the light emitting panel assembly or to interlock the electrical connector portions. Furthermore, the source electrical connector, the driver electrical connector, and the electrical connector portions which form these electrical connectors, can use various types of mobile electrical connectors and/or fixed electrical connectors, beyond the types exemplified in this patent application.

To illustrate aspects of the disclosed technology in a clear and concise manner, the drawings may not necessarily be to scale and certain features may be shown in somewhat schematic form.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A light fixture comprising:
(a) a light emitting panel assembly comprising a frame, and a light emitting diode (LED) panel that is substantially flat and disposed within the frame and that includes an array of LEDs; and,
(b) a power circuit module releasably attachable to the light emitting panel assembly, said power circuit module including a power circuit; a decouplable source electrical connector that electrically couples the power circuit to a power supply external to the light fixture; and a decouplable driver electrical connector that electrically couples the power circuit to the array of LEDs.

2. The light fixture of claim 1, wherein the power supply external to the light fixture is an AC power supply, and the power circuit converts AC power to DC power to drive the LEDs.

3. The light fixture of claim 1, wherein the decouplable driver electrical connector includes a first driver electrical connector portion electrically coupled to the power circuit, and a second driver electrical connector portion electrically coupled to the array of LEDs and releasably connectable to the first driver electrical connector portion.

4. The light fixture of claim 3, wherein the power circuit module is configured to be detached and separated from the light emitting panel assembly, and wherein the first driver electrical connector portion and second driver electrical connector portion are configured to be disconnected and separated as the power circuit module is separated from the light emitting panel assembly.

5. The light fixture of claim 3, wherein the first driver electrical connector portion comprises a DC-power connector having a female configuration, and the second driver electrical connector portion comprises a DC-power connector having a male configuration.

6. The light fixture of claim 1, wherein the decouplable source electrical connector includes a first source electrical connector portion electrically coupled to the power circuit, and a second source electrical connector portion electrically coupled to the power supply external to the light fixture and releasably connectable to the first source electrical connector portion.

7. The light fixture of claim 6, wherein the power circuit module is configured to be detached and separated from the light emitting panel assembly, and wherein the first source electrical connector portion and second source electrical connector portion are configured to be disconnected and separated as the power circuit module is separated from the light emitting panel assembly.

8. The light fixture of claim 6, wherein the first source electrical connector portion comprises an AC-power connector having a male configuration, and the second source electrical connector portion comprises an AC-power connector having a female configuration.

9. The light fixture of claim 6, wherein the second source electrical connector portion includes a luminaire disconnect.

10. The light fixture of claim 1, wherein the decouplable driver electrical connector includes a first driver electrical connector portion electrically coupled to the power circuit, and a second driver electrical connector portion electrically coupled to the array of LEDs and releasably connectable to the first driver electrical connector portion, and
wherein the decouplable source electrical connector includes a first source electrical connector portion electrically coupled to the power circuit, and a second source electrical connector portion electrically coupled to the power supply external to the light fixture and releasably connectable to the first source electrical connector portion.

11. The light fixture of claim 10, wherein the second driver electrical connector portion and the second source electrical connector portion are secured to the frame of the light emitting panel assembly.

12. The light fixture of claim 1, wherein the power circuit, the decouplable source electrical connector, and the decouplable driver electrical connector are disposed within a channel defined by the power circuit module and by the light emitting panel assembly.

13. The light fixture of claim 12, wherein the power circuit comprises a printed circuit board having a length and a width, wherein a length-to-width ratio thereof is at least ten-to-one.

14. The light fixture of claim 13, wherein the decouplable driver electrical connector includes a first driver electrical connector portion secured to the printed circuit board, and the decouplable source electrical connector includes a first source electrical connector portion secured to the printed circuit board.

15. The light fixture of claim 1, wherein the power circuit module is releasably attachable to the light emitting panel assembly with mechanical fasteners.

16. The light fixture of claim 1, wherein the power circuit module is releasably attachable to the light emitting panel assembly via interference fit.

17. The light fixture of claim 1, wherein the light fixture further includes a device for mounting the light fixture in an installation, and wherein the light fixture is configured so that the power circuit module can be detached and separated from the light emitting panel assembly without removing the light fixture from the installation.

18. The light fixture of claim 17, wherein the light fixture is configured so that the power circuit module can be detached and separated from the light emitting panel assembly from a front surface of the light fixture.

19. The light fixture of claim 17, wherein the light fixture is configured so that the power circuit module can be detached and separated from the light emitting panel assembly from a rear surface of the light fixture.

20. The light fixture of claim 1, wherein the light emitting panel assembly comprises an LEDs module and a remaining portion of the light emitting panel assembly, and wherein the LEDs module contains the array of LEDs and is releasably attachable to the remaining portion of the light emitting panel assembly and to the power circuit module.
